(19) United States
(12) Patent Application Publication
(10) Pub. No.: US 2026/0187229 A1
(43) Pub. Date: Jul. 2, 2026

(54) Agentless database protection

(71) Applicant: DBDome Ltd., Tirat HaCarmel (IL)

(72) Inventors: Yoram Dan, Tel Aviv (IL); Tal Cohen, Tirat HaCarmel (IL)

(21) Appl. No.: 19/198,051

(22) Filed: May 4, 2025

Related U.S. Application Data
(60) Provisional application No. 63/740,361, filed on Dec. 31, 2024.

(51) Int. Cl. G06F 21/55; G06F 21/57

(52) U.S. Cl. CPC G06F 21/55; G06F 21/577

(57) ABSTRACT

Systems, methods, and computer program products for protecting databases are disclosed. A computer implemented method for protecting one or more databases installed on one or more servers from security threats includes interrogating the one or more databases by a monitoring database installed on a monitoring server to identify security threats to the one or more databases, where the monitoring server is different from the one or more servers, and once a security threat to a database of the one or more databases is identified, applying one or more countermeasures, respectively.

### CROSS-REFERENCE TO RELATED APPLICATION

This application claims the benefit of U.S. Provisional Patent Application 63/740,361, filed Dec. 31, 2024, which is incorporated herein by reference.

### FIELD

The present disclosure relates generally to cybersecurity, and more specifically, to systems, methods and computer program products for protecting databases from cybersecurity threats.

### BACKGROUND

Database security is highly important and may include various measures designed to protect databases from malicious attacks, misuse and unauthorized access. Common threats to database security include Structured Query Language (SQL) injection, unauthorized use of sensitive data, insider threats and more.

Database attacks may lead to data theft, customer reimbursement, regulatory fines or reputation damage and may cost millions of dollars to fix. In today's digital landscape, which is rapidly evolving, safeguarding data is more crucial than ever.

### SUMMARY

The present disclosure relates to systems, methods and computer program products for protecting data storage, e.g., databases, and access to such. The disclosed systems, methods and computer program products may identify, protect and optionally neutralise cybersecurity threats. The disclosed systems, methods and computer program products ensure that data remains protected from unauthorized access and cyber threats. The disclosed systems, methods, computer program products and apps provide a secure, compliant, and performance-optimized solution, e.g., for organizations managing critical and sensitive data across dynamic and often complex environments.

In accordance with aspects of the present disclosure, a computer implemented method for protecting at least one or more databases installed on one or more servers from security threats includes interrogating the one or more databases by a monitoring database installed on a monitoring server to identify security threats to the one or more databases, where the monitoring server is different than the one or more servers and once a security threat to a database of the one or more databases is identified, applying one or more countermeasures, respectively.

In various embodiments of the method, the interrogation of the one or more databases is performed in an agentless manner.

In various embodiments of the method, the interrogation of the one or more databases is performed by the monitoring server remotely connecting to the one or more servers, respectively.

In various embodiments of the method, the interrogation is performed by sending SQL queries issued by the monitoring database to the one or more databases.

In various embodiments of the method, the interrogation is performed online.

In various embodiments of the method, the monitoring server is a multitasking server configured to allow multiple interrogation processes to be performed at the same time.

In various embodiments of the method, the method further includes obtaining one or more sets of rules, where the interrogation of the one or more databases is performed according to the one or more sets of rules.

In various embodiments of the method, one or more rules of the one or more sets of rules are based on one or more metrics.

In various embodiments of the method, each metric is assigned with one or more thresholds and the security threats are identified by comparing the result of the metric to its assigned one or more thresholds.

In various embodiments of the method, the one or more thresholds of each metric are determined in a dynamic manner.

In various embodiments of the method, each set of rules includes a decision tree.

In various embodiments of the method, each decision tree is configured to identify a certain database security problem in the one or more databases.

In various embodiments of the method, the obtaining of the set of rules includes predefining at least a portion of the set of rules.

In various embodiments of the method, the application of one or more countermeasures includes at least one of: reporting the identified security threat, masking data of the database, or neutralizing the attack.

In various embodiments of the method, the method further includes providing a user interface to be utilized by an administrator of the database.

In various embodiments of the method, the monitoring server is installed on the premises of the owner of the one or more databases.

In various embodiments of the method, the monitoring server is installed on a cloud as a Software as a Service (SaaS).

In various embodiments of the method, the interrogation is performed in a continuous manner.

In accordance with aspects of the present disclosure, a system for protecting one or more databases installed on one or more servers from security threats is disclosed. The system includes at least one controller, and at least one computer readable storage device storing instructions for execution by the at least one controller. The instructions, when executed, cause the system to continuously interrogate the one or more databases by a monitoring database installed on a monitoring server different than the one or more servers, to identify security threats to the one or more databases, and once a security threat to a database of the one or more databases is identified, apply one or more countermeasures, respectively.

In various embodiments of the system, the system further includes the monitoring server and the monitoring database.

In various embodiments of the system, the interogation of the one or more databases is performed in an agentless manner.

In various embodiments of the system, the interogation of the one or more databases is performed by the monitoring server remotly connecting to the one or more servers, respectively.

In various embodiments of the system, the interogation is performed by sending SQL queries issued by the monitoring database to the one or more databases.

In various embodiments of the system, the interogation is performed online.

In various embodiments of the system, the monitoring server is a multitasking server configured to allow multiple interogation processes to be performed at the same time.

In various embodiments of the system, the instructions, when executed, further cause the system to obtain one or more sets of rules, where the interogation of the one or more databases is performed according to the one or more sets of rules.

In various embodiments of the system, one or more rules of the one or more sets of rules are based on one or more metrics.

In various embodiments of the system, each metric is assigned with one or more thresholds and the security threats are identified by comparing the result of the metric to its assigned one or more thresholds.

In various embodiments of the system, the one or more thresholds of each metric are determined in a dynamic manner.

In various embodiments of the system, each set of rules includes a decision tree.

In various embodiments of the system, each decision tree is configured to identify a certain database security problem in the one or more databases.

In various embodiments of the system, the obtaining of the set of rules includes predefining at least a portion of the set of rules.

In various embodiments of the system, the application of one or more countermeasures includes at least one of: reporting the identified security threat, masking data of the database, or neutralizing the attack.

In various embodiments of the system, the instructions, when executed, further cause the system to provide a user interface to be utilized by an administrator of the database.

In various embodiments of the system, the monitoring server is installed on the premises of the owner of the one or more databases.

In various embodiments of the system, the monitoring server is installed on a cloud as a Software as a Service (SaaS).

In various embodiments of the system, the interogation is performed in a continuous manner.

In accordance with aspects of the present disclosure, a method for setting up data protection from security threats for at least one or more databases installed on one or more servers is disclosed. The method includes installing a monitoring server different than the one or more servers and configured to remotely connect to the one or more servers, and installing a monitoring database on the monitoring server, where the monitoring database is configured to interrogate the one or more databases to identify security threats to the one or more databases.

In accordance with aspects of the present disclosure, a computer program product includes a computer-readable storage medium having computer-executable instructions for interrogating one or more databases installed on one or more servers by a monitoring database installed on a monitoring server to identify security threats to the one or more databases, where the monitoring server is different than the one or more servers, and once a security threat to a database of the one or more databases is identified, applying one or more countermeasures, respectively.

In various embodiments of the computer program product, the interogation of the one or more databases is performed in an agentless manner.

In various embodiments of the computer program product, the interogation of the one or more databases is performed by the monitoring server remotly connecting to the one or more servers, respectively.

In various embodiments of the computer program product, the interogation is performed by sending SQL queries issued by the monitoring database to the one or more databases.

In various embodiments of the computer program product, the interogation is performed online.

In various embodiments of the computer program product, the monitoring server is a multitasking server configured to allow multiple interogation processes to be performed at the same time.

In various embodiments of the computer program product, the computer-readable storage medium have further computer-executable instructions for obtaining one or more sets of rules, where the interogation of the one or more databases is performed according to the one or more sets of rules.

In various embodiments of the computer program product, one or more rules of the one or more sets of rules are based on one or more metrics.

In various embodiments of the computer program product, each metric of the one or more metrics is assigned with one or more thresholds where the security threats are identified by comparing the result of the metric to its assigned one or more thresholds.

In various embodiments of the computer program product, the one or more thresholds of each metric are determined in a dynamic manner.

In various embodiments of the computer program product, each set of rules includes a decision tree.

In various embodiments of the computer program product, each decision tree is configured to identify a certain database security problem in the one or more databases.

In various embodiments of the computer program product, the obtaining of the set of rules includes predefining at least a portion of the set of rules.

In various embodiments of the computer program product, the application of one or more countermeasures includes at least one of: reporting the identified security threat, masking data of the database, or neutralizing the attack.

In various embodiments of the computer program product, the computer-readable storage medium have further computer-executable instructions for providing a user interface to be utilized by an administrator of the database.

In various embodiments of the computer program product, the monitoring server is installed on the premises of the owner of the one or more databases.

In various embodiments of the computer program product, the monitoring server is installed on a cloud as a Software as a Service (SaaS).

In various embodiments of the computer program product, the interogation is performed in a continuous manner.

### BRIEF DESCRIPTION OF THE DRAWINGS

The above and other aspects and features of the disclosure will become more apparent in view of the following detailed description when taken in conjunction with the accompanying drawings wherein like reference numerals identify similar or identical elements.

FIG. 1 is a diagram of systems for protecting databases, in accordance with aspects of the disclosure;

FIG. 2 is a flow diagram of a computer implemented method for protecting databases, in accordance with aspects of the disclosure;

FIG. 3 is a diagram illustrating an exemplary process for protecting databases based on decision trees, in accordance with aspects of the disclosure;

FIG. 4 is a flow diagram of a method for setting up database protection, in accordance with aspects of the disclosure;

FIG. 5 is an exemplary screen of a Graphical User Interface (GUI) of a User Interface (UI) displaying activity related to protection of databases, in accordance with aspects of the present disclosure; and

FIG. 6 is a further exemplary screen of the GUI of FIG. 4, displaying various reports which may be generated in accordance with aspects of the present disclosure.

It will be appreciated that for simplicity and clarity of illustration, elements shown in the figures have not necessarily been drawn to scale. For example, the dimensions and/or aspect ratio of some of the elements can be exaggerated relative to other elements for clarity. Further, where considered appropriate, reference numerals can be repeated among the figures to indicate corresponding or analogous elements throughout the serial views.

### DETAILED DESCRIPTION

The present disclosure relates to systems, methods and computer program products for identifying, protecting or neutralising cybersecurity threats. The disclosed systems, methods, computer program products and apps are designed to provide a secure, efficient, and highly scalable database management environment, which may be specifically tailored for handling sensitive data across complex organizational infrastructures and protection of data storage and access within high-security contexts.

The present disclosure allows the protection of databases in a remote or agentless manner. Using agents installed on servers including data to be protected requires multiplicity of installations (e.g., installing one or more agents in each server) while the agents running on each server consume its resources and may put the server at risk. Furthermore, using agents requires a process of control. Thus, it is highly advantageous to protect data via a separate or a different server, without “stepping into” the servers to be protected, in an agentless manner.

The present disclosure further provides proactive protection by actively identifying and neutralizing threats before they can impact a client's business operations. The present disclosure introduces a unique model that complements the four classical pillars of cybersecurity (Prevent, Detect, Respond, Recover) by adding a critical layer of deterrence.

Moreover, the present disclosure provides an Artificial-Intelligence (AI)-driven threat identification which adapts to emerging threats including continuous learning capabilities, by that ensuring robust protection, which helps to stay ahead of evolving cyber threats.

In the following detailed description, specific details are set forth in order to provide a thorough understanding of the disclosure. However, it will be understood by those skilled in the art that the disclosure may be practiced without these specific details. In other instances, well-known methods, procedures, and components have not been described in detail so as not to obscure the present disclosure. Some features or elements described with respect to one system may be combined with features or elements described with respect to other systems. For the sake of clarity, discussion of same or similar features or elements may not be repeated.

Although the disclosure is not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although the disclosure is not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like. The term set, when used herein, may include one or more items. Although the disclosure is not limited in this regard, by using the term “or” when listing two or more items or options, it is meant that each item, and each plausible or feasible combination of the listed items including a combination of all listed items may be considered.

Unless explicitly stated, the methods described herein are not constrained to a particular order or sequence. Additionally, some of the described methods or elements thereof can occur or be performed simultaneously, at the same point in time, or concurrently.

The term “server”, as referred to herein, may relate to a physical server or to a virtual server.

The term “transaction”, as referred to herein, may include a query, data updating (e.g., deletion, addition), data retrieval or any other operation performed on a database.

The terms “app” or “application” may be used interchangeably and refer to and include software or programs having machine-executable instructions which can be executed by one or more processors to perform various operations.

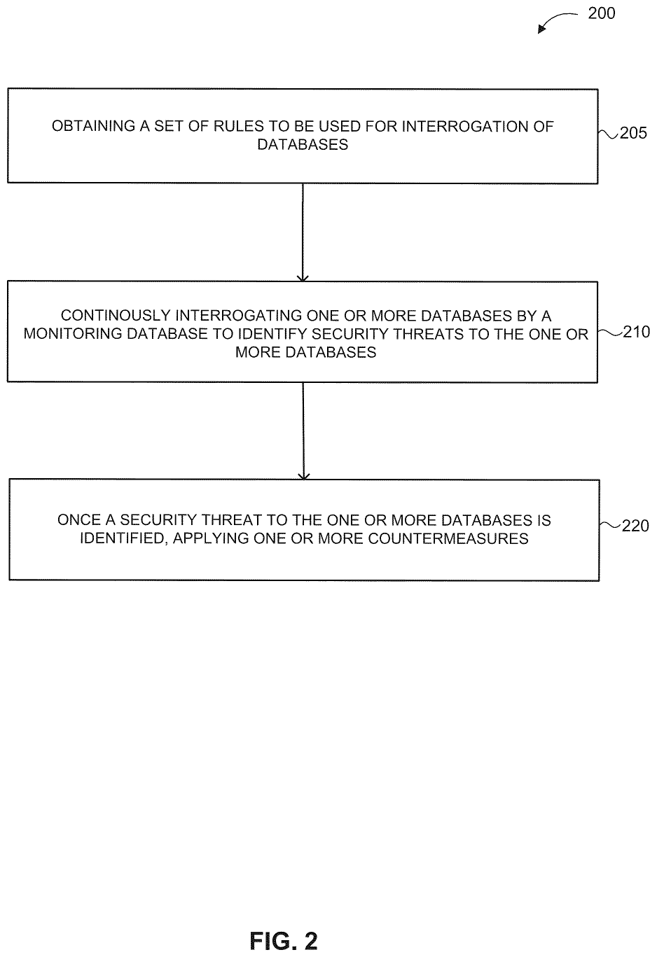

A system for protecting one or more databases installed on one or more servers from security threats is further disclosed. The system may include at least one controller and at least one computer readable storage device storing instructions for execution by the at least one controller. The instructions, when executed, may cause the system to apply the disclosed methods, such as method 200 of FIG. 2, as will be detailed herein below. According to some aspects, the system may further include the monitoring server and the monitoring database.

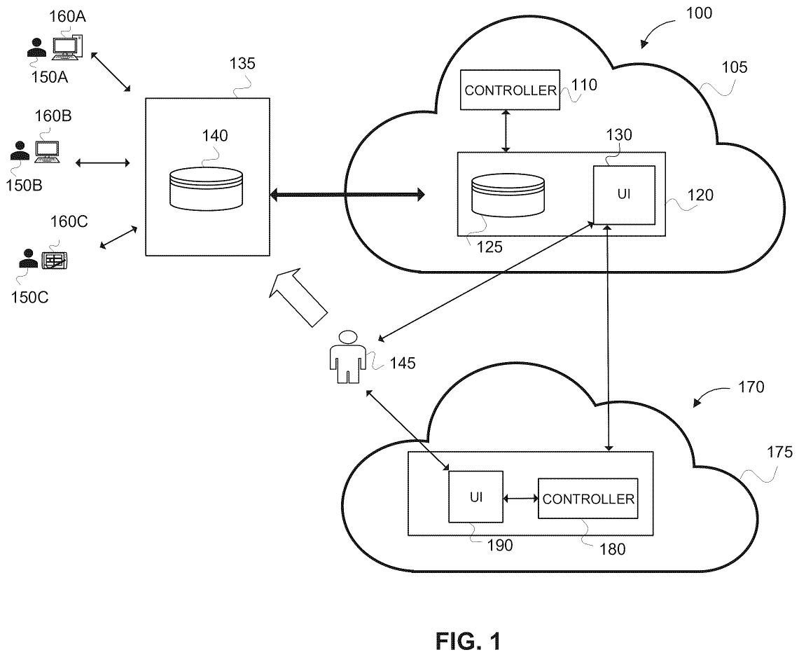

Reference is now made to FIG. 1, which is a diagram of a systems 100 and a system 170 for protecting databases according to the present disclosure. System 100 may include a controller 110 and a monitoring server 110. Monitoring server 110 may include a monitoring database 125 and optionally a dedicated UI 130. According to some aspects, controller 110 may include one or more controllers. According to some aspects, controller 110 may be included in monitoring server 110 or at least one controller of controller 110.

System 100 may be in communication with one or more servers 135 including one or more databases 140. Each server of servers 135 may include one or more databases of databases 140. Monitoring server is a different or a separate server from servers 135, at least logically. Monitoring server 120 may be configured to remotely connect to servers 135. According to some aspects, database 125 may be configured to generate SQL queries for interrogating databases 140, e.g., via a dedicated engine. According to some aspects, server 120 and database 125 may not receive, store or include the data of the client or the data to be protected, such as the data of databases 140. According to some aspects, server 120 and database 125 may receive, store or include metrics information or data relating to databases 140 and servers 135.

In some cases, servers 135 and databases 140 may be accessed by authorized end users such as end users 150A-150C via computerized devices such as Personal Computer (PC) 160A, terminal 160B or a tablet 160C, respectively. Servers 135 and databases 140 may include data owned, kept or managed by a client or a user of system 100 such as an enterprise, a government organization, Small and Midsize Businesses (SMBs) with significant database assets, financial institutions, healthcare organizations, E-commerce platforms or any other entity interested in keeping the data protected from unauthorized access or cyber threats. System 100 may be deployed on or using the infrastructure of the client (e.g., on-premises, private cloud, public cloud or semi-public cloud) and may be managed by the client once deployed and connected to the client's environment (e.g., servers 135). System 100 may be configured to be deployed in various environments (development, staging, or production), including cloud, such as cloud 105, and on-premises configurations. According to some aspects, servers 140 and monitoring server 120 may be deployed on the same infrastructure or platform owned or managed by the client, such as cloud 105 or a server farm.

According to some aspects, system 100 may provide a dedicated UI 130 which may issue or output alerts, reports and allow setting the operation of system 100. Additionally, or alternatively, system 100 may connect with applications of the client including various user-facing applications (e.g., web portals, mobile apps) that may access system 100 for data retrieval and storage.

A user 145 may act for the client and may be, for example, a Development Operations (DevOps) professional or a Data Base Administrator (DBA), e.g., administrating databases 140. User 145 may interact with, or manage the operation of system 100, e.g., via UI 130.

System 170 may include a controller 180 and may optionally include a UI 190. System 170 may be deployed, for example, on a cloud such as cloud 175 (e.g., a cloud-platform) or on-premises. System 170 may interact with system 100 to allow, for example, receipt of alerts, updating, troubleshooting, maintenance, monitoring or collection of data with respect to the operation of system 100 for business analytics purposes. According to some aspects, such interaction may be via UI 130 and upon permission of the client, e.g., by establishing a Virtual Private Network (VPN). According to some aspects, system 170 may provide an external dedicated UI 190, e.g., deployed on an external cloud, in addition to or alternatively to UI 130. User 145 or any other user of system 100 may interact with UI 190.

According to some aspects, system 100 may connect with various external entities, including client applications, external databases and data sources which may include databases other than databases 140 or third-party data providers that may feed data into system 100 or receive data from it, authentication and authorization systems such as identity management systems (e.g., Lightweight Directory Access Protocol, Single Sign-On, Multi-Factor Authentication solutions) for secure access control, and monitoring and logging services such as real-time monitoring tools and logging systems that track the performance and usage of system 100 for auditing and maintenance purposes.

FIG. 2 shows a flow diagram of a computer implemented method 200 for protecting one or more databases, such as databases 140 of FIG. 1, installed on one or more respective servers, such as servers 135 of FIG. 1, from security threats. Method 200 may be applied by the disclosed systems, such as system 100 of FIG. 1 and as exemplified below.

At a step 210, the one or more databases may be interrogated by a monitoring database to identify security threats to the databases. The one or more databases may be installed on a monitoring server. The monitoring server is different from or separate from the one or more servers on which the interrogated or protected databases are installed. According to some aspects, the interrogation is performed in an agentless manner. With reference to FIG. 1, one or more databases 140, which are installed on one or more servers 135, may be interrogated by monitoring database 125. Monitoring database 125 is installed on monitoring server 120 and is different from servers 135. One or more databases 140 are interrogated by monitoring database 125 to identify security threats to one or more databases 140, such as unauthorized access of an end-user such as end-users 150A-C to one or more databases 140. According to some aspects, the monitoring server may be installed on the premises of the owner or the keeper of the one or more databases (e.g., the client). According to some aspects, the monitoring server is installed on a cloud as a Software as a Service (SaaS).

According to some aspects, the interrogation of the one or more databases is performed by the monitoring server remotely connecting to the one or more servers, respectively. Referring to FIG. 1, server 120 may remotely connect to one or more servers 135 to allow the interrogation of one or more databases 140 by monitoring database 125.

According to some aspects, the interrogation is performed by sending SQL queries issued by the monitoring database (e.g., database 125) to the one or more databases (e.g., one or more databases 140). The interogation allows the collection of information of interest from target databases. According to some aspects, the interogation may be continuously performed, e.g., once in a defined time interval and in a rapid manner.

An interaction with a database may include a plurality of operations or stages, including a connection, a session and a transaction. One or more or all of these stages may be interrogated via queries. According to some aspects, one or more or all of servers 135 and one or more or all of databses 140 may be automatically interrogated. However, this may be set for or by each specific client according to his needs.

According to some aspects, the interrogation includes the monitoring server (e.g., server 120) running queries on remote servers (e.g., servers 135) to collect data and storing the returned data into respective tables. The tables may be stored, for example, on the monitoring server. According to some aspects, each query is or represents a metric. A metric may be, for example, a query asking for the active connections or a query asking for the number of reads at a certain time of a certain database by an end-user. The returned data for each query may be then the result of the metric. According to some aspects, each metric may be assigned with at least one threshold. According to some aspects, each metric may be assigned with three thresholds: low (or normal), (high or Mid) and critical. Once a metric result is received (e.g., in response to a query), it is determined if the result is within or exceeds the assigned one or more thresholds.

According to some aspects, the one or more thresholds assigned to each metric may be set in a dynamic manner. The one or more thresholds may be continuously recalculated or continuously or dynamically determined, e.g., once per a predefined time interval. The thresholds may be dynamically determined, e.g., for each metric, for each client or for each interrogated server. An optimal value may be dynamically determined for the thresholds based on predefined criteria, often used in anomaly detection, classification, or decision-making. The dynamic thresholds may be determined, e.g., based on the trends of the interrogated server. According to some aspects, the dynamic thresholds may be determined via a threshold configurator algorithm, e.g., based on AI, machine-learning or deep learning techniques. The dynamic thresholds may be determined, e.g., based on the calculation of a moving average.

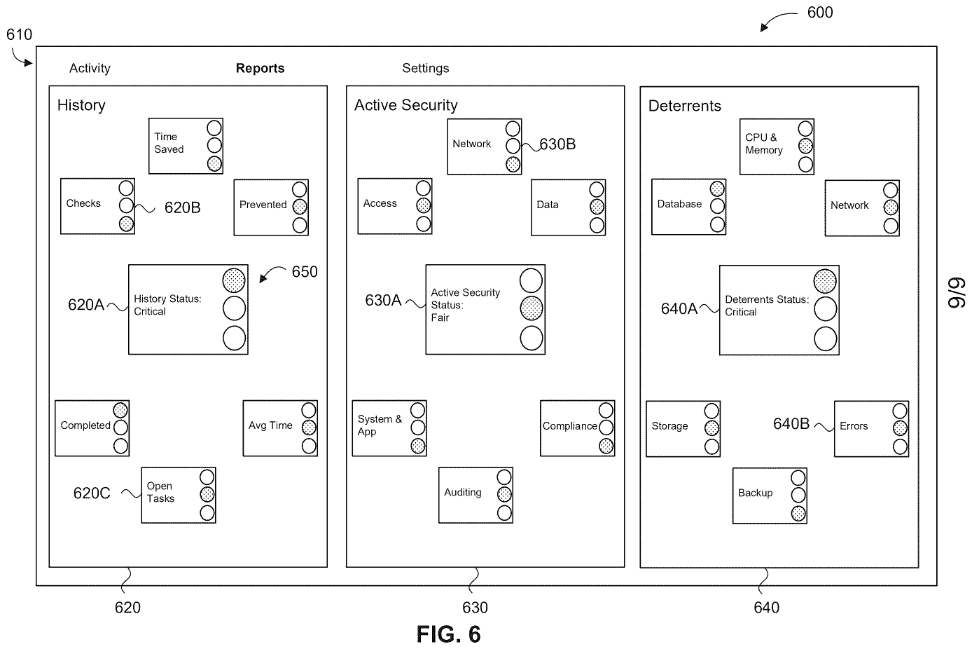

At a step 220, once a security threat to a database of the one or more databases is identified, one or more countermeasures may be applied, respectively. According to some aspects, the one or more countermeasures may include at least one of reporting the identified security threat, masking data of the database, closing the attacker's connection or neutralizing the attack. Reporting the identified security threat may include sending a notification mail to the user of the client, e.g., to user 145. Additionally or alternatively, an alert may appear on the screen of the user UI such as UI 130 or UI 190 or a respective report may be issued, e.g., available via a “Reports” tab via UI 130 or UI 190, as shown, for example, in FIG. 6. Masking data of the database at risk may include masking all of the data of the database or a portion of the data which is identified as being at risk, e.g., data stored in an area of the database to which an unauthorized user is trying to access. Neutralizing the attack may be performed, for example, by neutralizing the attacker's Transmission Control Protocol (TCP) connection or by making the attacker's connection non-useful or obsolete and even harmful. According to some aspects, neutralizing an attack may be performed by identifying a new connection from an unknown source and generating a situation according to which the connection is neutralized, e.g., not responding. For example, by replacing the query with a query that does not return results.

A computerized method for neutralizing an attack is further disclosed. At a pre-processing stage, the SQL connection and the SQL statement sent, may be identified. The SQL connection may be identified by capturing the source IP address of the incoming SQL connection which is running a statement at the very moment. The SQL statement sent may be identified by logging and analyzing the original SQL query sent by the end-user.

At a first step, the statement is replaced (e.g., Delay and Lock). It may be performed, for example, by replacing the original SQL statement with a crafted query that takes a long time to execute, by that delaying the SQL client's operation, and locking the SQL client, by that creating resource contention preventing the client from progressing normally.

At a second step, the statement is replaced e.g., (Memory Holding). The SQL statement is replaced again with another crafted query designed to hold significant client memory. This creates memory-intensive operations, consuming the client's resources and potentially causing performance degradation or application crashes.

Neutralizing an attack, as disclosed herein, may be performed or utilized by any system or method known to a person skilled in the art aimed at protecting databases and is not limited to, e.g., the disclosed systems and methods, which provide database protection based on an agentless architecture.

According to some aspects, the interrogation of the one or more databases or the application of the one or more countermeasures may be performed according to or based on a set of rules. One or more rules of the set of rules may be based on one or more metrics. The set of rules may be implemented via or based on various techniques as known to a person skilled in the art. According to some aspects, the set of rules is, includes or is implemented as one or more decision trees.

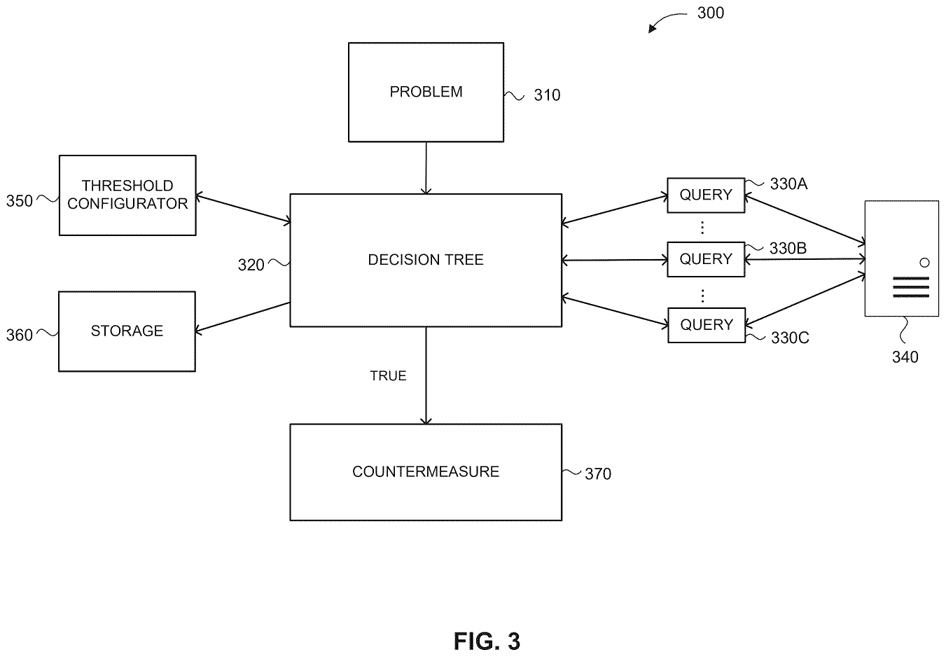

Reference is now made to FIG. 3, which is a diagram illustrating an exemplary process 300 for protecting databases based on decision trees. A decision tree 320 may be activated. Decision tree 320 may be generated or defined to check for a potential problem 310 relating to database security. Decision tree 320, may be, for example, a statistical model implemented as SW-based instructions to be executed by one or more controllers. Referring to FIG. 1, decision trees such as decision tree 320 may be implemented as SW instructions stored on monitoring database 125 and executed by controller 110 of system 100. Decision tree 320 may send multiple queries, such as queries 330A, 330B and 330C to an interrogated server such as server 340. Server 340 may include one or more databases to be interrogated. Each query such as queries 330A-330C is or includes a metric and returns the metric result. The returned metrics results may be then stored, e.g., in one or more tables on a storage device such as storage 360. The output of decision tree 320 may include a binary result indicating if problem 310 was identified in the interrogated database or not, e.g., by TRUE/FALSE. If problem 310 was identified in the interrogated database, e.g., by outputting “TRUE”, then a suitable or a corresponding one or more actions or countermeasures 370 may be applied, e.g., in order to fix, mitigate or neutralize the problem. According to some aspects, the application of countermeasure 370, in case of identifying a security problem, e.g., problem 310 by decision tree 320 is performed automatically. According to some aspects, only a portion of the countermeasures (e.g., one or more but not all) are applied automatically. According to some aspects, a threshold configurator 350 (e.g., an AI-based algorithm) may continuously determine one or more dynamic thresholds for each query or metric of decision tree 320 for interrogated server 340, e.g., based on identified trends of server 340. For example, according to a rule of the set of rules applied by decision tree 320, a metric of transaction time may be checked, inter alia, to identify problem 310. The transaction time is checked in view of the determined relevant trend to determine if there is an anomaly. The currently identified relevant trend may affect the determination or may determine the value of the one or more thresholds of the metric. If there is an anomaly, e.g., the transaction time exceeds one or more of the thresholds assigned to this metric, further rules may be applied. If there isn't an anomaly, e.g., the transaction time is within the low threshold range, then other rules may be further applied.

According to some aspects, the values of the metrics compared to the dynamic thresholds may affect the applied countermeasure 370. For example, if problem 310 is an anomaly with respect to transaction time, then a transaction time exceeding the low threshold may trigger a different action or countermeasure 370 than a transaction time which exceeds the critical threshold.

According to some aspects, metric results, actions taken and additional information may be output by decision tree 320 and stored in storage 360 including the identified rootcause and related information. The output data may be then presented to the user or client, e.g., via reports displayed via UI 130 or 190 of FIG. 1 and as exemplified in FIG. 6 hereinbelow. According to some aspects, the output data may be further analyzed to receive further statistics, insights and the like to be reported to the user or for Business Intelligence (BI) purposes.

FIG. 3 exemplifies the operation of a single decision tree. However, an interogation according to the present disclosure may be performed based on multiple sets of rules and multiple metrics implemented or applied via multiple decision trees. Each decision tree of the multiple decision trees may continuously interrogate multiple databases installed on multiple servers.

At an optional step 205, the set of rules may be obtained. The obtaining of the set of rules may include predefining at least a portion of the set of rules. According to some aspects, at least a portion of the set of rules is defined by the client or user. The client may decide to add rules or to edit the rules. According to some aspects, decision tree algorithms may be generated according to the specific client needs.

According to some aspects, the interrogation is performed online or substantially online, e.g., to allow an online handling of an identified threat. According to some aspects, the monitoring server may be a multitasking server configured to allow multiple interrogation processes to be performed at the same time, e.g., on the same database, on the same server or on multiple servers. Accordingly, interrogation of multiple databases or of multiple servers may be performed in parallel. According to some aspects, the interrogation is performed in a parallel manner, multithreaded-like, via SQL.

A method for allowing interrogation of databases in parallel may include enabling access to the operating system of the monitoring server e.g., to the shell of the operating system,

Setting up a table for task management (e.g., creating a table for managing tasks which need to be executed in parallel While each task can include a command, its status (e.g., “Pending,” “Running,” “Completed”), and any relevant output), inserting commands into the queue, e.g., by populating the table with the commands one wish to execute using the shell and implementing parallelism by using shell commands.

According to some aspects, the method may further include Updating of the table and monitoring and logging Outputs.

According to some aspects, method 200 may further include the step of providing a user interface to be utilized by a user or a client, e.g., an administrator of the databases to be protected. With reference to FIG. 1, a UI 130 or a UI 190 may be provided. According to some aspects, UI 190 may be a web-based application. According to some aspects, UI 190 may provide a more limited but less invasive UI, which does not require logging into the client's system, as required for accessing UI 130.

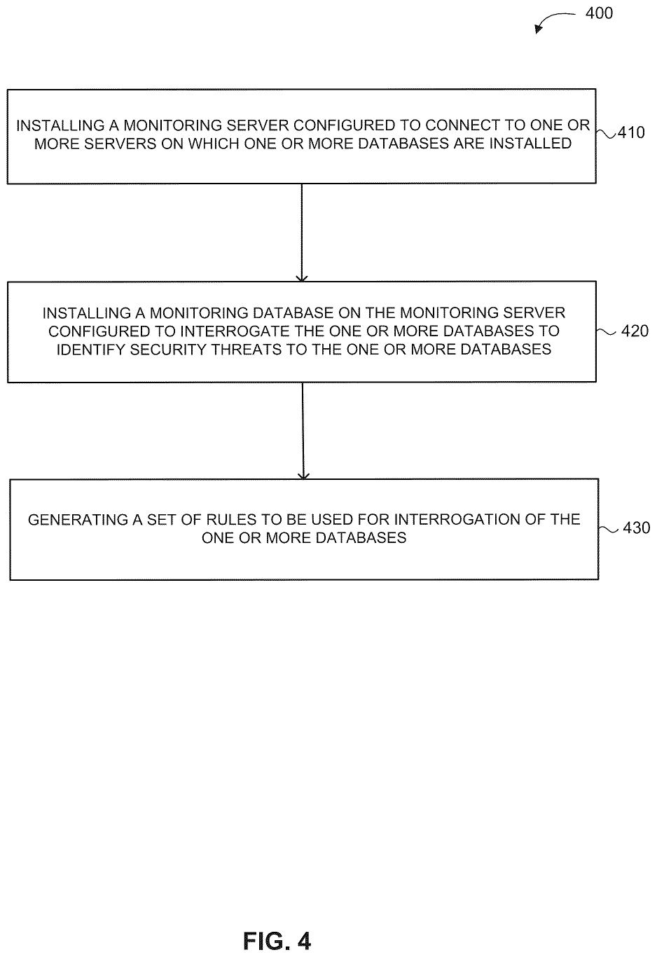

Reference is now made to FIG. 4 which is a flow diagram of a method 400 for setting up database protection from security threats for at least one or more databases installed on one or more servers. At a step 310, a monitoring server different from the one or more servers may be installed. The monitoring server may be configured to remotely connect to the one or more servers. At a step 320, a monitoring database configured to interrogate the one or more databases to identify security threats may be installed. The monitoring database is installed on the monitoring server. At an optional step 330, a set of rules to be used for the interrogation of the one or more databases may be generated. The monitoring server and the monitoring database may be or may operate as described herein above, e.g., with respect to FIGS. 1 to 3.

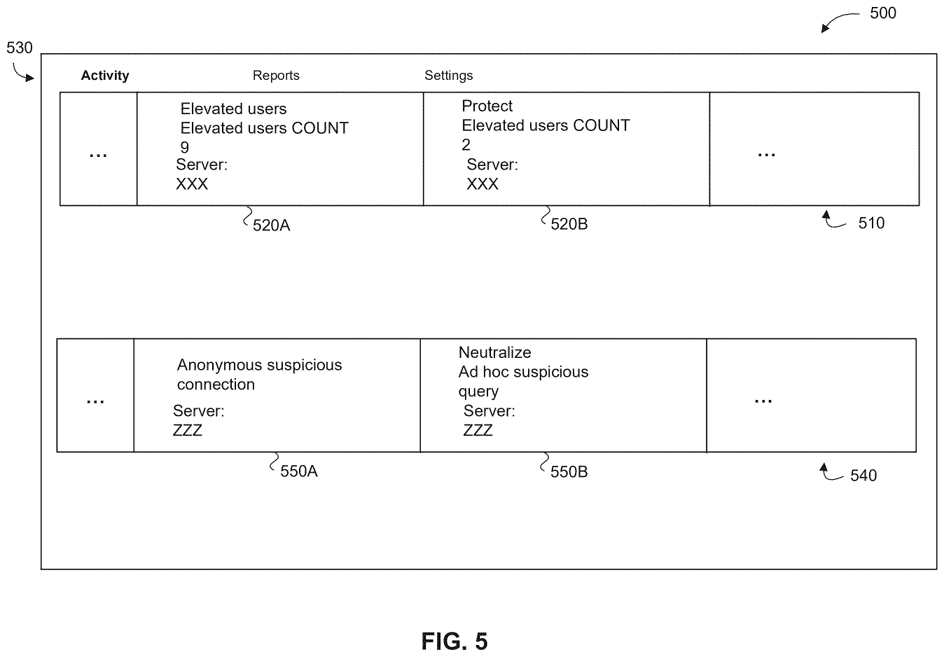

Reference is now made to FIG. 5 and FIG. 6. FIG. 5 shows an exemplary main screen 500 of a GUI displaying activity related to the protection of databases according to the present disclosure. FIG. 6 shows a further exemplary main screen of the GUI of FIG. 5, displaying various reports which may be generated according to the present disclosure. According to some aspects, the disclosed systems and methods may support complex data queries for generating reports, analytics, and insights, e.g., via UI 130 or UI 190.

As shown in FIGS. 5 and 6, the GUI (e.g., of UI 130 or UI 190) may include a plurality of main screens included in a menu indicated 530 and 610, respectively. The menu may include: “Activity”, “Reports”, and “Settings”, referring to various main screens which may be displayed to the user.

Main screen 500 may be a part of a front-end dashboard showing the multiprocessing of all actions performed by a system such as system 100 of FIG. 1, including metrics and event investigation (e.g., identification of root cause and measures taken).

With reference to FIG. 5, which shows the “Activity” main screen 500, one or more running widgets 510 and 540 may be presented including identified issues or anomalies and actions or countermeasures taken in response. For example, an issue or anomaly of “Elevated users” 520A, according to which users with high permissions access an object or a table they should have not accessed was identified. A “Protect” action 520B was taken in response, e.g., by closing the transaction or connection of such users or masking the data in the accessed table or object. As another example, an anomaly 550A of an anonymous suspicious connection was identified. A countermeasure taken 550B of neutralizing the suspicious query 550B was performed in response.

With reference to FIGS. 1 and 3, system 100 (via monitoring database 125) may review all the checked metrics (e.g., data retrieved by queries such as queries 330A-330C of FIG. 3). Once an anomaly is identified, it may be presented on the dashboard (such as anomalies notifications 520A and 550A) and the countermeasure applied (such as countermeasures notifications 520B and 550B, respectively).

Referring now to FIG. 6, which shows the “Reports” main screen 600 and allows the generation of various reports. Screen 600 may be divided into a plurality of areas 620, 630 and 640 including different categories of reports: “Activity”, “Active Security” and “Deterrents”. According to some aspects, such division into categories may be set by the user or client or according to the client's needs. For example, “History” 620 may include reports relating to past events which are no longer active, like “History Status: Critical” report 620A (e.g., a report listing all anomalies determined as critical based on the assigned thresholds which are no longer active and their handling is complete), “Checks” report 620B or “Open Tasks” report 620C. “Active Security” 630 may include reports relating to events that are currently handled or recently handled and are not yet entered into “History” 620, such as “Active Security Status: Fair” report 630A (e.g., a report listing all anomalies determined as fair (or Mid or high) based on the assigned thresholds and are still active or were active until recently and not yet included in “History”) or “Network” report 630B. “Deterrents” 640 may include reports including information about the countermeasures taken, such as “Deterrents Status: Critical” report 640A or “Errors” report 640B.

According to some aspects, each report may be assigned with a traffic-light-like icon, such as icon 650, indicating the level or average of metrics currently included or referred to in the specific report: low/informative (bottom “light” indicated), fair/high/Mid (middle “light” indicated) or critical (upper “light” indicated). The indication may be by color, e.g., like a traffic light: green, yellow and red, by graphical patterns such as shown in FIG. 6 (dotted pattern) and the like.

A further “Setting” main menu may be included in the GUI (not shown). The “Settings” main screen may be used by a user or a client of the disclosed systems, such as system 100 or system 170 of FIG. 1, to customize the operation of the disclosed systems, such as system 100 of FIG. 1, including the content or design of the UI, such as UI 130, according to the client's needs or requirements. Accordingly, the user may, for example, determine the metrics or add or remove metrics on which the interrogation is based, determine which and when servers and databases in his environment are interrogated, which problems or issues are checked for, determine initial values for metrics thresholds, determine which reports may be generated via the UI etc.

A computer program product including a computer-readable storage medium having computer-executable instructions for interrogating or for causing the interrogation of one or more databases installed on one or more servers is further disclosed. The interrogation is performed by a monitoring database installed on a monitoring server to identify security threats to the one or more databases, where the monitoring server is different from the one or more servers. Once a security threat to a database of the one or more databases is identified, the instructions are configured to cause the application of one or more countermeasures, respectively. According to some aspects, the interrogation is performed in an agentless manner. According to some aspects, the interrogation is performed by sending SQL queries issued by the monitoring database to the one or more databases.

The computer program product may be or may include one or more storage devices such as a storage device of monitoring server 120 or of system 100 of FIG. 1 or storage 360 of FIG. 3. According to some aspects, the computer-executable instructions may be configured to trigger or cause the performance of the disclosed methods, including method 200 of FIG. 2 or method 400 of FIG. 4.

The computerized systems disclosed herein, such as systems 100 and 170 of FIG. 1 may include a processor or controller (e.g., controller 110 or 180) that may be or include, for example, one or more central processing unit processor(s) (CPU), one or more Graphics Processing Unit(s) (GPU or GPGPU), and/or other types of processors, such as a microprocessor, digital signal processor, microcontroller, programmable logic device (PLD), field programmable gate array (FPGA), or any suitable computing or computational device. The computerized systems may also include a memory, a storage, a communication device or an operating system.

The operating system may be or may include any code designed and/or configured to perform tasks involving coordination, scheduling, arbitration, supervising, controlling or otherwise managing the operation of the disclosed computerized system. The memory may be or may include, for example, one or more Random Access Memory (RAM), read-only memory (ROM), flash memory, volatile memory, non-volatile memory, cache memory, and/or other memory devices. The memory may store, for example, executable instructions that carry out an operation (e.g., executable code) and/or data. Executable code may be any executable code, e.g., an app/application, a program, a process, task or script. Executable code may be executed by the controller such as controller 110 of system 100 or controller 180 of system 170.

The storage may be or may include, for example, one or more of a hard disk drive, a solid state drive, an optical disc drive (such as DVD or Blu-Ray), a USB drive or other removable storage device, and/or other types of storage devices. Data such as instructions, code, procedure data, among other things, may be stored in the storage and may be loaded from the storage into the memory where it may be processed by the controller (e.g., controller 110 or 180).

The illustrated components of FIG. 1 are exemplary and variations are contemplated to be within the scope of the present disclosure. For example, the numbers of components may be greater or fewer than as described and the types of components may be different than as described. When the disclosed systems implement a data storage system, a large number of storages may be utilized. As another example, when the disclosed systems implement a server system, a large number of central processing units or cores may be utilized. Other variations and applications are contemplated to be within the scope of the present disclosure.

Unless specifically stated otherwise, as apparent from the preceding discussions, it is appreciated that throughout the specification discussions utilizing terms such as “processing”, “computing”, “storing”, “determining”, “causing” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. Furthermore, unless stated otherwise, the term “causing” may also include triggering, e.g., triggering one or more action and/or processes of a computer or computing system or similar electronic computing device, which may cause the indicated result.

Different aspects are disclosed herein. Features of certain aspects can be combined with features of other aspects; thus, certain aspects can be combinations of features of multiple aspects.

While several embodiments of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A computer implemented method for protecting at least one or more databases installed
on one or more servers from security threats, the method comprising:
interrogating the one or more databases by a monitoring database installed on a monitoring server to identify security threats to the one or more databases, wherein the monitoring server is different from the one or more servers; and
once a security threat to a database of the one or more databases is identified, applying one or more countermeasures, respectively.

2. The method according to claim 1, wherein the interrogation of the one or more databases is performed in an agentless manner.

3. The method according to claim 1, wherein the interrogation is performed by sending SQL queries issued by the monitoring database to the one or more databases.

4. The method according to claim 1, wherein the interrogation is performed online.

5. The method according to claim 1, wherein the monitoring server is a multitasking server configured to allow multiple interrogation processes to be performed at the same time.

6. The method according to claim 1, further comprising obtaining one or more sets of rules, wherein the interrogation of the one or more databases is performed according to the one or more sets of rules, and wherein one or more rules of the one or more sets of rules are based on one or more metrics.

7. The method according to claim 6, wherein each metric of the one or more metrics is assigned with one or more thresholds and wherein the security threats are identified by comparing the result of the metric to its assigned one or more thresholds.

8. The method according to claim 7, wherein the one or more thresholds of each metric are determined in a dynamic manner.

9. The method according to claim 6, wherein each set of rules of the one or more sets of rules comprises a decision tree, and wherein each decision tree is configured to identify a certain database security problem in the one or more databases.

10. The method according to claim 1, wherein the monitoring server is installed on the premises of the owner of the one or more databases or installed on a cloud as a Software as a Service (SaaS).

11. The method according to claim 1, wherein the interrogation is performed in a continuous manner.

12. A system for protecting one or more databases installed on one or more servers from security threats, the system comprising:
at least one controller;
at least one computer readable storage device storing instructions for execution by the at least one controller, the instructions, when executed, cause the system to:
continuously interrogate the one or more databases by a monitoring database installed on a monitoring server different from the one or more servers, to identify security threats to the one or more databases; and
once a security threat to a database of the one or more databases is identified, apply one or more countermeasures, respectively.

13. The system according to claim 12, further comprising the monitoring server and the monitoring database.

14. The system according to claim 12, wherein the interrogation of the one or more databases is performed in an agentless manner.

15. The system according to claim 12, wherein the interrogation is performed by sending SQL queries issued by the monitoring database to the one or more databases.

16. The system according to claim 12, wherein the interrogation is performed online.

17. The system according to claim 12, wherein the monitoring server is a multitasking server configured to allow multiple interrogation processes to be performed at the same time.

18. The system according to claim 12, wherein the instructions, when executed, further cause the system to obtain one or more sets of rules, wherein:
the interrogation of the one or more databases is performed according to the one or more sets of rules,
one or more rules of the one or more sets of rules are based on one or more metrics,
each metric of the one or more metrics is assigned with one or more thresholds, and
the security threats are identified by comparing the result of the metric to its assigned one or more thresholds.

19. The system according to claim 18, wherein the one or more thresholds of each metric are determined in a dynamic manner.

20. A computer program product comprising a computer-readable storage medium having computer-executable instructions for:
interrogating one or more databases installed on one or more servers by a monitoring database installed on a monitoring server to identify security threats to the one or more databases, wherein the monitoring server is different from the one or more servers; and
once a security threat to a database of the one or more databases is identified, applying one or more countermeasures, respectively.

21. The computer program product according to claim 20, wherein the interrogation of the one or more databases is performed in an agentless manner.

22. The computer program product according to claim 20, wherein the interrogation is performed by sending SQL queries issued by the monitoring database to the one or more databases.

23. The computer program product according to claim 20, wherein the interrogation is performed online.

24. The computer program product according to claim 20, wherein the monitoring server is a multitasking server configured to allow multiple interrogation processes to be performed at the same time.

25. The computer program product according to claim 20, wherein the computer-readable storage medium has further computer-executable instructions for obtaining one or more sets of rules, and wherein:
the interogation of the one or more databases is performed according to the one or more sets of rules,
one or more rules of the one or more sets of rules are based on one or more metrics,
each metric of the one or more metrics is assigned with one or more thresholds,
the one or more thresholds of each metric are determined in a dynamic manner, and
the security threats are identified by comparing the result of the metric to its assigned one or more thresholds.
